(19) United States
(12) Patent Application Publication
(10) Pub. No.: US 2022/0276945 A1
(43) Pub. Date: Sep. 1, 2022

(54) ESTIMATION APPARATUS, ESTIMATION METHOD, AND NON-TRANSITORY COMPUTER READABLE MEDIUM

(71) Applicant: NEC Corporation, Minato-ku, Tokyo (JP)

(72) Inventor: Seng Pei LIEW, Tokyo (JP)

(73) Assignee: NEC Corporation, Minato-ku, Tokyo (JP)

(21) Appl. No.: 17/628,322

(22) PCT Filed: Jul. 29, 2019
(86) PCT No.: PCT/JP2019/029587

§ 371 Date: Jan. 19, 2022

(51) Int. Cl. G06F 11/30

(52) U.S. Cl. CPC G06F 11/3079; G06F 2201/86

(57) ABSTRACT

In an estimation apparatus (10), an execution unit (12) performs an attaching process. The attaching process is a process in which the execution unit (12) repeats processes including setting a search range for an event sequence acquired, identifying an event identification information unit (an information unit) whose last modified time is closest to the present time among information units included in the set range, attaching reference time information to the identified information unit, and setting a next range for all information units that are earlier than the aforementioned identified information unit in the order of occurrences in the sequence. An estimation unit (13) estimates, for each of the information units included in the sequence, an occurrence period where an event of that information unit occurred based on the last modified time(s) of the information unit(s) to which the reference time information was attached.

### TECHNICAL FIELD

The present disclosure relates to an estimation apparatus, an estimation method, and a non-transitory computer readable medium.

### BACKGROUND ART

In a number of computers, an “event sequence” in which a plurality of event identification information units about a plurality of respective events that have occurred in the computer are arranged in the order of occurrences of the events is acquired (see, for example, Non-patent Literature 1). In the “event sequence”, each of “event identification information units” is associated with a time stamp (e.g., a last modified time) of a file corresponding to that event identification information unit. The “event identification information unit” is, for example, a “file path” of the corresponding file.

In the technique disclosed in Non-patent Literature 1, a person finds an event identification information unit of a target event of which the person wants to estimate the time of occurrence from the event sequence, and then finds an event identification information unit of a specific event which is located near an event identification information unit corresponding to the target event in the event sequence and whose last modified time is known to be equal to the time of its occurrence beforehand. Then, the person estimates the time of occurrence of the target event by using the last modified time of the event identification information unit of the specific event whose last modified time is known to be equal to the time of its occurrence beforehand.

### CITATION LIST

### Non Patent Literature

Non-patent Literature 1: Timothy Parisi, “Threat Research, Caching Out: The Value of Shimcache for Investigators”, [online], [Searched on Jun. 11, 2019], Jun. 17, 2015, FireEye, Inc, Internet <https://www.fireeye.com/blog/threat-research/2015/06/caching_out_the_val.html>

### SUMMARY OF INVENTION

### Technical Problem

However, in the technique disclosed in Non-patent Literature 1, unless the person knows the information about the specific event whose last modified time is equal to the time of its occurrence beforehand, there is a possibility that he/she cannot estimate the time of occurrence of the target event.

The present inventors have found that there is a characteristic that in an event sequence, an event identification information unit corresponding to an event whose last modified time is equal to the time of its occurrence is associated with a last modified time that is closer to the present time than last modified times of other event identification information units are. Further, the present inventors have found that it is possible to improve the accuracy of estimation by identifying, by using the above-described characteristic, an event identification information unit corresponding to an event whose last modified time is equal to the time of its occurrence and estimating the time of occurrence (an occurrence period) of a target event based on the last modified time corresponding to the identified event identification information unit.

An object of the present disclosure is to provide an estimation apparatus, an estimation method, and a non-transitory computer readable medium capable of improving the accuracy of estimation of the time of occurrence of a target event.

### Solution to Problem

An estimation apparatus according to a first aspect includes:

acquisition unit configured to acquire an event sequence in which a plurality of event identification information units about a plurality of respective events are arranged in the order of occurrences of these events and each of the event identification information units is associated with a last modified time of a file corresponding to that event identification information unit;

execution unit configured to perform a reference time information attaching process in which the execution means repeats, until an end condition is satisfied, processes including setting a search range for the event sequence, identifying an event identification information unit whose last modified time is closest to the present time among event identification information units included in the search range, attaching reference time information to the identified event identification information unit, and setting a next search range for all event identification information units that are earlier than the identified event identification information unit in the order of occurrences in the event sequence; and

estimation unit configured to estimate, for each of the event identification information units included in the event sequence, an occurrence period in which an event of that event identification information unit occurred based on the last modified time of the event identification information unit to which the reference time information was attached by the execution means.

An estimation method according to a second aspect includes:

acquiring an event sequence in which a plurality of event identification information units about a plurality of respective events are arranged in the order of occurrences of these events and each of the event identification information units is associated with a last modified time of a file corresponding to that event identification information unit;

performing a reference time information attaching process in which setting a search range for the event sequence, identifying an event identification information unit whose last modified time is the latest among event identification information units included in the search range, attaching reference time information to the identified event identification information unit, and setting a next search range for all event identification information units that are earlier than the identified event identification information unit in the order of occurrences in the event sequence are repeated until an end condition is satisfied; and

estimating, for each of the event identification information units included in the event sequence, an occurrence period in which an event of that event identification information unit occurred based on the last modified time of the event identification information unit to which the reference time information was attached by the reference time information attaching process.

A non-transitory computer readable medium according to a third aspect stores a program for causing an estimation apparatus to:

acquire an event sequence in which a plurality of event identification information units about a plurality of respective events are arranged in the order of occurrences of these events and each of the event identification information units is associated with a last modified time of a file corresponding to that event identification information unit;

perform a reference time information attaching process in which setting a search range for the event sequence, identifying an event identification information unit whose last modified time is the latest among event identification information units included in the search range, attaching reference time information to the identified event identification information unit, and setting a next search range for all event identification information units that are earlier than the identified event identification information unit in the order of occurrences in the event sequence are repeated until an end condition is satisfied; and

estimate, for each of the event identification information units included in the event sequence, an occurrence period in which an event of that event identification information unit occurred based on the last modified time of the event identification information unit to which the reference time information was attached by the reference time information attaching process.

### Advantageous Effects of Invention

According to the present disclosure, it is possible to provide an estimation apparatus, an estimation method, and a non-transitory computer readable medium capable of improving the accuracy of estimation of the time of occurrence of a target event.

### BRIEF DESCRIPTION OF DRAWINGS

FIG. 1 is a block diagram showing an example of an estimation apparatus according to a first example embodiment.

FIG. 2 is a table showing an example of an event sequence.

FIG. 3 is a flow chart showing an example of processing operations performed by the estimation apparatus according to the first example embodiment.

FIG. 4 is a block diagram showing an example of an estimation apparatus according to a second example embodiment.

FIG. 5 is a table showing an example of an event sequence in which each of event identification information units is associated with an occurrence period estimated for that event identification information unit.

FIG. 6 is a flowchart showing an example of a reference time information attaching process according to the second example embodiment.

FIG. 7 is a diagram for explaining an example of a reference time information attaching process.

FIG. 8A is a part of a flowchart showing an example of an occurrence period estimating process according to the second example embodiment.

FIG. 8B is the remaining part of a flowchart showing an example of an occurrence period estimating process according to the second example embodiment.

FIG. 9 is a diagram for explaining an example of an occurrence period estimating process.

FIG. 10 is another diagram for explaining an example of an occurrence period estimating process.

FIG. 11 is a block diagram showing an example of an estimation apparatus according to a third example embodiment.

FIG. 12 is a diagram for explaining a reference time information correcting process according to the third example embodiment.

FIG. 13 is a diagram showing an example of a hardware configuration of an estimation apparatus.

### DESCRIPTION OF EMBODIMENTS

Example embodiments will be described hereinafter with reference to the drawings. In the example embodiments, the same or equivalent elements are denoted by the same reference signs and duplicated descriptions are omitted.

### First Example Embodiment

### <Configuration Example of Estimation Apparatus>

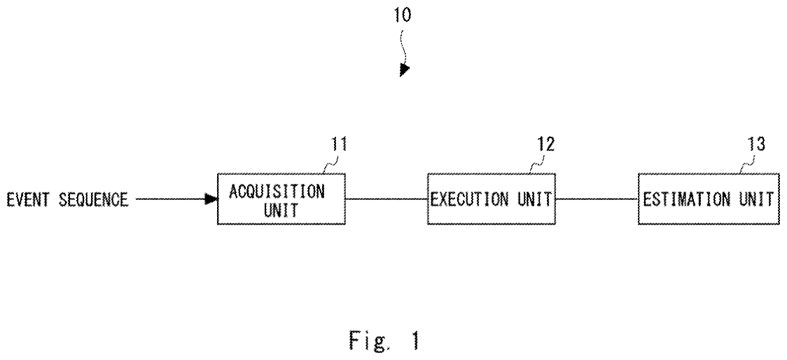

FIG. 1 is a block diagram showing an example of an estimation apparatus according to a first example embodiment. In FIG. 1, the estimation apparatus 10 includes an acquisition unit 11, an execution unit 12, and an estimation unit 13. The estimation apparatus 10 is, for example, included in or connected to a computer.

The acquisition unit 11 acquires an “event sequence”. The “event sequence” is a sequence in which a plurality of event identification information units about a plurality of respective events that have occurred in a computer are arranged in the order of occurrences of these events. Further, in the “event sequence”, each of the “event identification information units” is associated with a time stamp (e.g., a last modified time) of a file corresponding to that event identification information unit.

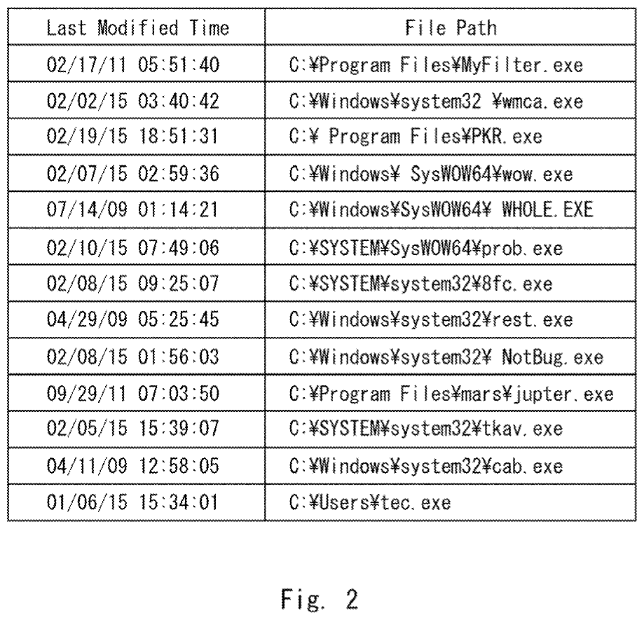

FIG. 2 is a table showing an example of an event sequence. In the event sequence (an event list) shown in FIG. 2, file paths are associated with last modified times for these file paths. That is, in the event sequence shown in FIG. 2, the file paths are used as “event identification information units”.

The execution unit 12 executes a “reference time information attaching process”. In the “reference time information attaching process”, the below-shown processes are repeated until an “end condition” is satisfied. That is, the execution unit 12 first sets a “search range” for the event sequence acquired by the acquisition unit 11. In the initial setting of the “search range”, a search range is set for, for example, the entire event sequence. Then, the execution unit 12 identifies an event identification information unit whose last modified time is closest to the present time among event identification information units included in the set search range, and attaches “reference time information” to the identified event identification information unit. Then, the execution unit 12 sets the next “search range” for all the event identification information units that are earlier than the aforementioned identified event identification information unit in the order of occurrences in the event sequence. The above-described processes are repeated until an “end condition” is satisfied.

The “end condition” may be, for example, a fact that there is no event identification information unit that is earlier than the aforementioned identified event identification information unit in the order of occurrences in the event sequence. Alternatively, the “end condition” may be a fact that the number of event identification information units that are earlier than the aforementioned identified event identification information unit in the order of occurrences in the event sequence is equal to or smaller than a predetermined number. Alternatively, the “end condition” may be a fact that the number of repetitions in the “reference time information attaching process” has reached a predetermined number.

The estimation unit 13 estimates, for each of the event identification information units included in the event sequence, an occurrence period in which an event of that event identification information unit occurred based on the last modified time(s) of the event identification information unit(s) to which reference time information was attached by the execution unit 12.

### <Example of Operation Performed by Estimation Apparatus>

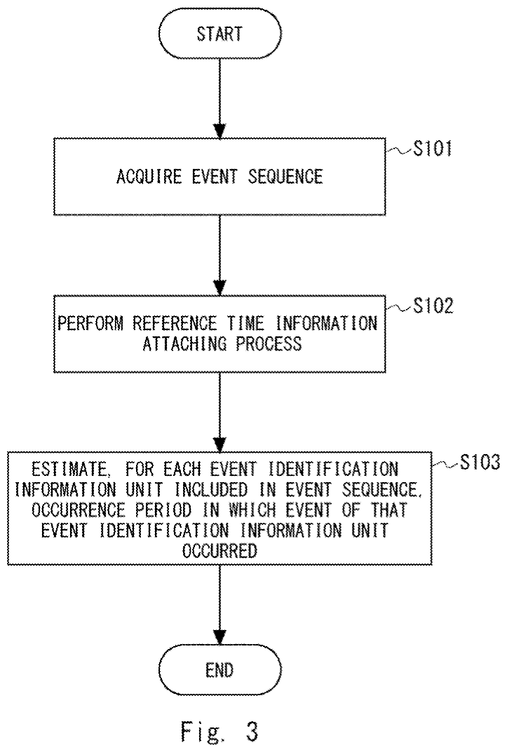

An example of processing operations performed by the estimation apparatus having the above-described configuration is described. FIG. 3 is a flowchart showing an example of processing operations performed by the estimation apparatus according to the first example embodiment.

The acquisition unit 11 acquires an “event sequence” (step S101).

The execution unit 12 performs a “reference time information attaching process” (step S102).

The estimation unit 13 estimates, for each of the event identification information units included in the event sequence, an occurrence period in which an event of that event identification information unit occurred (step S103).

As described above, according to the first example embodiment, in the estimation apparatus 10, the execution unit 12 performs the “reference time information attaching process”. The “reference time information attaching process” is a process in which the execution unit 12 repeats, until the end condition is satisfied, processes including setting a “search range” for the event sequence acquired by the acquisition unit 11, identifying an event identification information unit whose last modified time is closest to the present time among event identification information units included in the set search range, attaching “reference time information” to the identified event identification information unit, and setting a next “search range” for all event identification information units that are earlier than the aforementioned identified event identification information unit in the order of occurrences in the event sequence. The estimation unit 13 estimates, for each of the event identification information units included in the event sequence, an occurrence period in which an event of that event identification information unit occurred based on the last modified time(s) of the event identification information unit(s) to which reference time information was attached by the execution unit 12.

By the above-described configuration of the estimation apparatus 10 and by using the “characteristic that in an event sequence, an event identification information unit corresponding to an event whose last modified time is equal to the time of its occurrence is associated with a last modified time that is closer to the present time than last modified times of other event identification information units are”, it is possible to identify an event identification information unit corresponding to an event whose last modified time is equal to the time of its occurrence. Further, it is possible to improve the accuracy of estimation of an occurrence period of a target event by estimating the occurrence period of the target event by using the last modified time corresponding to the identified event identification information unit as a reference time.

### Second Example Embodiment

A second example embodiment relates to a more specific example embodiment of the method for estimating an occurrence period.

### <Configuration Example of Estimation Apparatus>

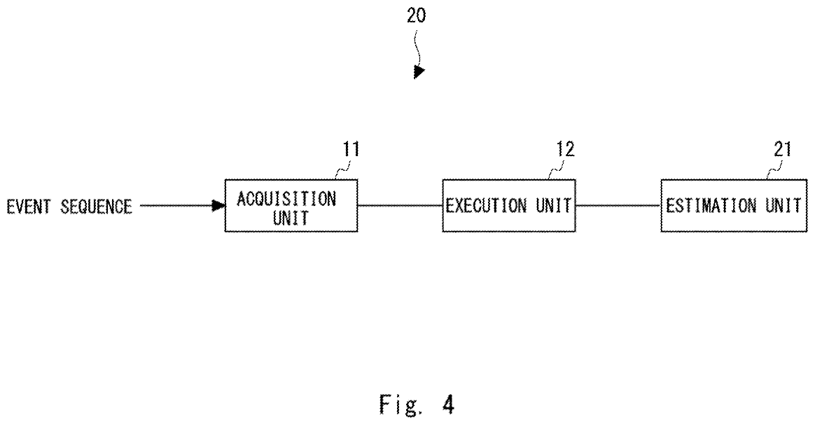

FIG. 4 is a block diagram showing an example of an estimation apparatus according to the second example embodiment. In FIG. 4, the estimation apparatus 20 includes an acquisition unit 11, an execution unit 12, and an estimation unit 21.

The estimation unit 21 estimates that, for example, an occurrence period of third event identification information with no reference time information attached thereto, located between first and second event identification information units to each of which respective reference time information is attached in the event sequence, corresponds to a period that starts at the last modified time of the second event identification information unit and ends at the last modified time of the first event identification information unit. For example, when there are a plurality of event identification information units which are later than the third event identification information unit in the order of occurrences in the event sequence and to each of which reference time information is attached, the estimation unit 21 may select an event identification information unit which is later than and closest to the third event identification information unit in the order of occurrences in the event sequence and to which reference time information is attached as the first event identification information unit. Further, for example, when there are a plurality of event identification information units which are earlier than the third event identification information unit in the order of occurrences in the event sequence and to each of which reference time information is attached, the estimation unit 21 may select an event identification information unit which is earlier than and closest to the third event identification information unit in the order of occurrences in the event sequence and to which reference time information is attached as the second event identification information unit.

Further, for example, when there is no event identification information unit which is later than the first event identification information unit in the order of occurrences in the event sequence and to which reference time information is attached, the estimation unit 21 may estimate that an occurrence period of a fourth event identification information unit which is later than the first event identification information unit in the order of occurrences in the event sequence and to which no reference time information is attached corresponds to a period that starts at the last modified time of the first event identification information unit.

Further, for example, when there is no event identification information unit which is earlier than the second event identification information unit in the order of occurrences in the event sequence and to which reference time information is attached, the estimation unit 21 may estimate that an occurrence period of a fifth event identification information unit which is earlier than the second event identification information unit in the order of occurrences in the event sequence and to which no reference time information is attached corresponds to a period that ends at the last modified time of the second event identification information unit.

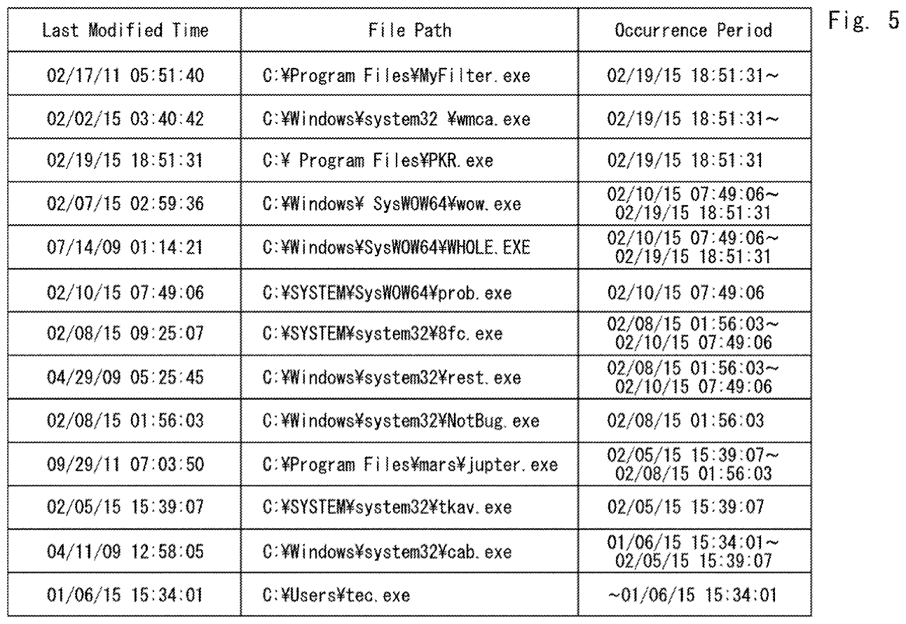

The estimation unit 21 may output the event sequence in which each of the event identification information units is associated with an occurrence period estimated for that event identification information unit to a functional unit (e.g., a storage unit) at an output stage. FIG. 5 is a table showing an example of an event sequence in which each of event identification information units is associated with an occurrence period estimated for that event identification information unit.

### <Example of Operation Performed by Estimation Apparatus>

An example of processing operations performed by the estimation apparatus 20 having the above-described configuration is described.

### <Reference Time Information Attaching Process>

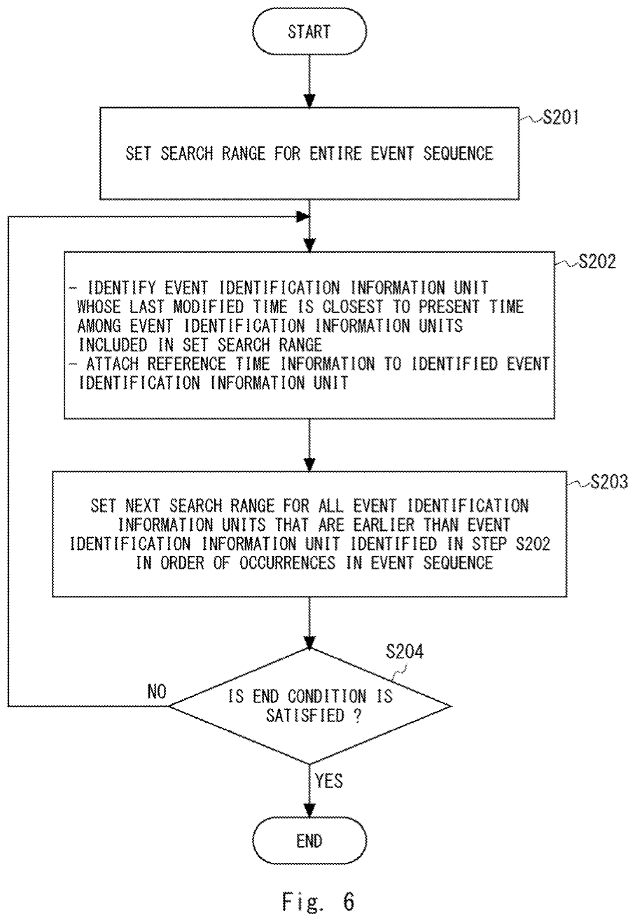

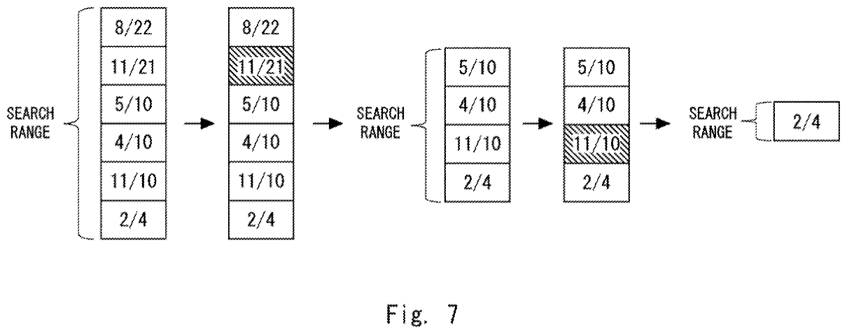

Firstly, an example of the “reference time information attaching process” is described. FIG. 6 is a flowchart showing an example of the reference time information attaching process according to the second example embodiment. FIG. 7 is a diagram for explaining the example of the reference time information attaching process.

The execution unit 12 sets a search range for the entire event sequence (step S201). In the leftmost part in FIG. 7, an event sequence is schematically shown. In FIG. 7, only last modified times (dates) corresponding to respective event identification information units in the event sequence are shown for simplifying the drawing. That is, in FIG. 7, for example, “8/22” means “August 22”. Further, for simplifying the drawing, FIG. 7 shows an event sequence composed of six event identification information units whose last modified times are in the same year as an example. Further, in the event sequence shown in FIG. 7, the event identification information units are shown in the descending order of the times of their occurrences. As shown in the leftmost part in FIG. 7, a search range is set for the entire event sequence.

The execution unit 12 identifies an event identification information unit whose last modified time is closest to the present time among event identification information units included in the set search range, and attaches “reference time information” to the identified event identification information unit (step S202). In the search range in the leftmost part in FIG. 7, the event identification information unit whose last modified time is closest to the present time is the event identification information unit whose last modified time is “11/21”. Therefore, as shown in the second part from the left in FIG. 7, the event identification information unit whose last modified time is “11/21” is identified and reference time information is attached to this event identification information unit. In FIG. 7, the reference time information is indicated by hatching.

The execution unit 12 sets the next “search range” for all the event identification information units that are earlier than the event identification information unit identified in the step S202 in the order of occurrences in the event sequence (step S203). As shown in the third part from the left in FIG. 7, the next “search range” is set for four event identification information units whose last modified times are “5/10”, “4/10”, “11/10” and “2/4”, respectively.

The execution unit 12 determines whether or not an end condition is satisfied (step S204). In this example, it is assumed that the “end condition” is a fact that the number of event identification information units included in the set search range is equal to or smaller than three.

When it is determined that the end condition is satisfied (Yes at step S204), the reference time information attaching process is finished.

When it is determined the end condition is not satisfied (No at step S204), the processing step returns to the step S202. In the example shown in FIG. 7, since the number of event identification information units included in the next search range set in the step S203 is four, the processing step returns to the step S202.

Then, as shown in the fourth part from the left in FIG. 7, the event identification information unit whose last modified time is “11/10” is identified and reference time information is attached to this event identification information unit. Then, as shown in the fifth part from the left in FIG. 7, the next “search range” is set for one event identification information unit whose last modified time is “2/4”. Since the number of event identification information units included in the “search range” is equal to or smaller than three, the end condition is satisfied. Therefore, the reference time information attaching process is finished. In the example shown in FIG. 7, eventually, reference time information is attached to each of the event identification information units whose last modified times are “11/21” and “11/10”, respectively, through the reference time information attaching process.

### <Estimating Process of Occurrence Period>

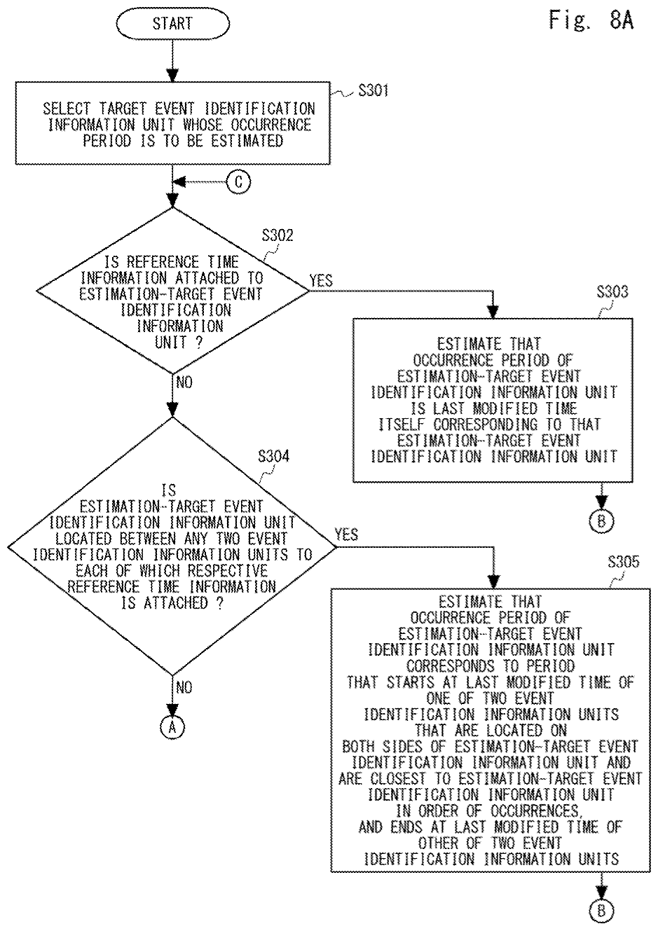

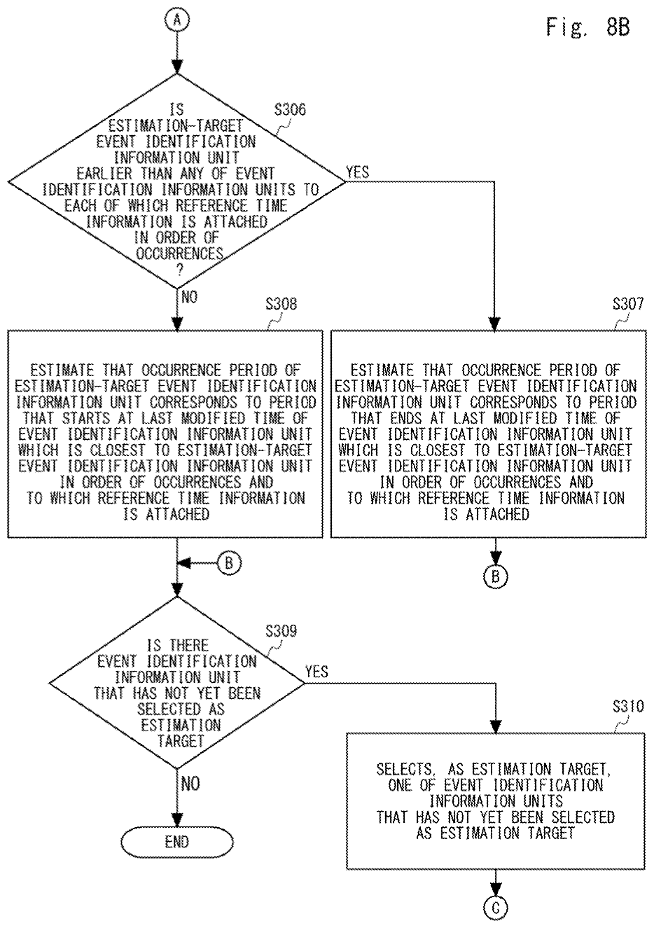

Next, a process for estimating an occurrence period is described. FIGS. 8A, 8B are a flowchart showing an example of an occurrence period estimating process according to the second example embodiment. FIG. 9 is a diagram for explaining the example of the occurrence period estimating process.

The estimation unit 21 selects a target event identification information unit whose occurrence period needs to be estimated from an event sequence including event identification information units to each of which reference time information is attached by the execution unit 12 (step S301).

The estimation unit 21 determines whether or not reference time information is attached to the selected estimation-target event identification information unit (step S302).

When reference time information is attached to the selected estimation-target event identification information unit (Yes at step S302), the estimation unit 21 estimates that the occurrence period of the estimation-target event identification information unit is the last modified time itself corresponding to that estimation-target event identification information unit (step S303). In the example shown in FIG. 9, since reference time information is attached to the event identification information unit whose last modified time is “11/21”, the occurrence period of the event identification information unit whose last modified time is “11/21” is “11/21” itself. The same applies to the event identification information unit whose last modified time is “11/10”.

When reference time information is not attached to the selected estimation-target event identification information unit (No at step S302), the estimation unit 21 determines whether or not the estimation-target event identification information unit is located between any two event identification information units to each of which respective reference time information is attached (step S304).

When the estimation-target event identification information unit is located between any two event identification information units to each of which respective reference time information is attached (Yes at step S304), the estimation unit 21 estimates that the occurrence period of the estimation-target event identification information unit corresponds to a period that starts at the last modified time of one of two event identification information units that are located on both sides of the estimation-target event identification information unit and are closest to the estimation-target event identification information unit in the order of occurrences, and ends at the last modified time of the other of the two event identification information units (step S305). In the example shown in FIG. 9, the event identification information unit whose last modified time is “5/10” is located between the event identification information units whose last modified times are “11/21” and “11/10”, respectively. Therefore, it is estimated that the occurrence period of the event identification information unit whose last modified time is “5/10” is “11/10 to 11/21”. The same applies to the event identification information unit whose last modified time is “4/10”.

When the estimation-target event identification information unit is not located between any two event identification information units to each of which reference time information is attached (No at step S304), the estimation unit 21 determines whether or not the estimation-target event identification information unit is earlier than any of event identification information units to each of which reference time information is attached in the order of occurrences (step S306).

When the estimation-target event identification information unit is earlier than any of event identification information units to each of which reference time information is attached in the order of occurrences (Yes at step S306), the estimation unit 21 estimates that the occurrence period of the estimation-target event identification information unit corresponds to a period that ends at the last modified time of an event identification information unit which is closest to the estimation-target event identification information unit in the order of occurrences and to which reference time information is attached (step S307). In the example shown in FIG. 9, it is estimated that the occurrence period of the event identification information unit whose last modified time is “2/4” is “to 11/10”.

When the estimation-target event identification information unit is later than any of event identification information units to each of which reference time information is attached in the order of occurrences (No at step S306), the estimation unit 21 estimates that the occurrence period of the estimation-target event identification information unit corresponds to a period that starts at the last modified time of an event identification information unit which is closest to the estimation-target event identification information unit in the order of occurrences and to which reference time information is attached (step S308). In the example shown in FIG. 9, it is estimated that the occurrence period of the event identification information unit whose last modified time is “8/22” is “from 11/21”.

The estimation unit 21 determines whether or not there is an event identification information unit that has not yet been selected as an estimation target (step S309).

When all the event identification information units have already been selected as an estimation target (No at step S309), the process for estimating an occurrence period is finished.

When there is an event identification information unit that has not yet been selected as an estimation target (Yes at step S309), the estimation unit 21 selects, as the estimation target, one of event identification information units that has not yet been selected as the estimation target (step S310). Then, the processing step returns to the step S302.

### Modified Example

The above descriptions have been given on the assumption that an occurrence period of an estimation-target event identification information unit is estimated based on the last modified time of an event identification information unit which is closest to the estimation-target event identification information unit in the order of occurrences and to which reference time information is attached. However, the present invention is not limited to such methods. For example, the estimation unit 21 may select, as the above-described first event identification information unit, an event identification information unit which is Nth closest to the above-described third event identification information unit (N is an integer) among event identification information units which are later than the above-described third event identification information unit in the order of occurrences in the event sequence and to each of which reference time information is attached. For example, the estimation unit 21 may select, as the above-described second event identification information unit, an event identification information unit which is Mth closest to the above-described third event identification information unit (M is an integer) among event identification information units which are earlier than the above-described third event identification information unit in the order of occurrences in the event sequence and to each of which reference time information is attached.

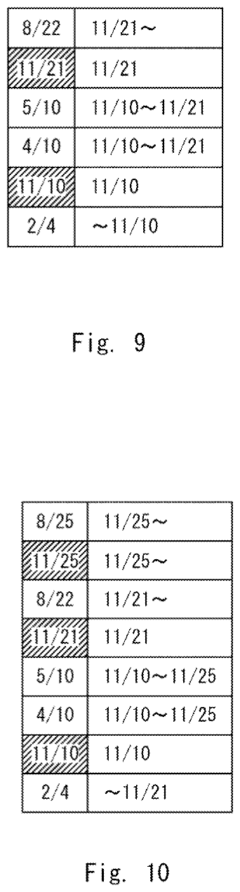

FIG. 10 is another diagram for explaining an example of an occurrence period estimating process. In FIG. 10, a case where N=2 and M=1 is shown. In FIG. 10, for example, a start time of an occurrence period of an event identification information unit whose last modified time is “5/10” is “11/10”, i.e., a last modified time of an event identification information unit which is earlier than and closest to the aforementioned event identification information unit in the order of occurrences and to which reference time information is attached. Further, an end time of the occurrence period of the event identification information unit whose last modified time is “5/10” is “11/25”, i.e., a last modified time of an event identification information unit which is later than and second closest to the aforementioned event identification information unit in the order of occurrences and to which reference time information is attached.

Further, for example, a start time of an occurrence period of an event identification information unit whose last modified time is “8/22” is “11/21”, i.e., a last modified time of an event identification information unit which is earlier than and closest to the aforementioned event identification information unit in the order of occurrences and to which reference time information is attached. Meanwhile, an end time of the occurrence period of the event identification information unit whose last modified time is “8/22” is not defined because there is no event identification information unit which is later than and second closest to the aforementioned event identification information unit in the order of occurrences and to which reference time information is attached.

Further, for example, a start time of an occurrence period of an event identification information unit whose last modified time is “2/4” is not defined because there is no event identification information unit which is earlier than and closest to the aforementioned event identification information unit in the order of occurrences and to which reference time information is attached. Meanwhile, an end time of the occurrence period of the event identification information unit whose last modified time is “2/4” is “11/21”, i.e., a last modified time of an event identification information unit which is later than and second closest to the aforementioned event identification information unit in the order of occurrences and to which reference time information is attached.

### Third Example Embodiment

The third example embodiment relates to a correction to reference time information.

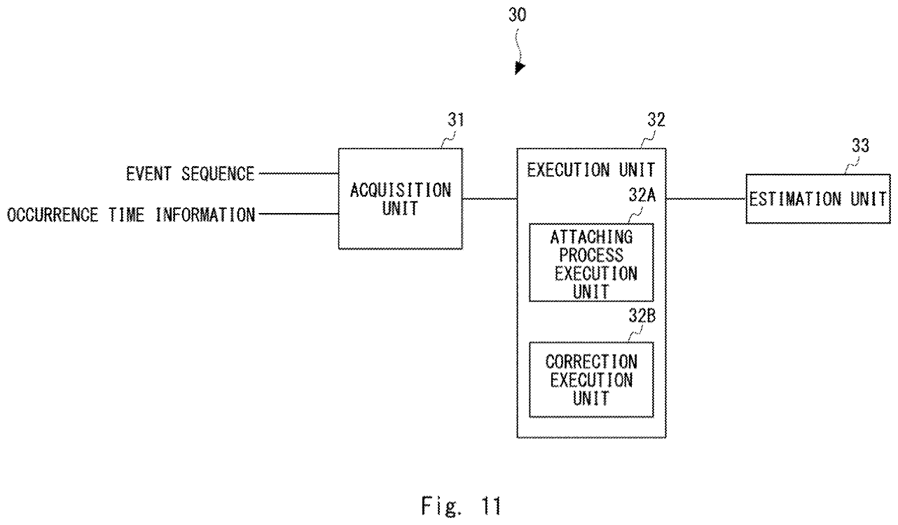

FIG. 11 is a block diagram showing an example of an estimation apparatus according to the third example embodiment. In FIG. 11, the estimation apparatus 30 includes an acquisition unit 31, an execution unit 32, and an estimation unit 33.

Similarly to the acquisition section 11 according to the first and second example embodiments, the acquisition unit 31 acquires an event sequence. Further, the acquisition unit 31 acquires an accurate time of occurrence of at least one event (an event identification information unit) among a plurality of events corresponding to a plurality of respective event identification information units included in an event sequence. For example, the acquisition unit 31 can externally acquire the actual time of occurrence of a certain event. For example, the acquisition unit 31 can acquire the actual time of occurrence of a certain event from a monitoring program that is installed in a computer and records certain activities.

The execution unit 32 includes an attaching process execution unit 32A and a correction execution unit 32B.

Similarly to the execution unit 12 of the first and second example embodiments, the attaching process execution unit 32A performs a “reference time information attaching process”.

The correction execution unit 32B corrects reference time information in an event sequence in which reference time information is attached by the attaching process execution unit 32A by using an accurate time of occurrence of the aforementioned at least one event acquired by the acquisition unit 31. For example, the correction execution unit 32B deletes, in the event sequence, reference time information of an event identification information unit with reference time information attached thereto, corresponding to a last modified time that is inconsistent with the accurate time of occurrence of the event identification information unit acquired by the acquisition unit 31. Further, the correction execution unit 32B attaches, in the event sequence, reference time information to an event identification information unit of which an accurate time of occurrence is obtained. By the correction to reference time information made by the correction execution unit 32B, the accuracy of estimation of an occurrence period can be improved.

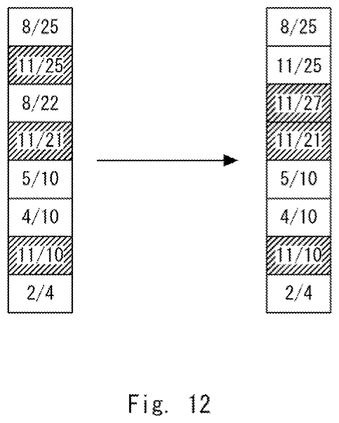

FIG. 12 is a diagram for explaining a reference time information correcting process according to the third example embodiment. The left part in FIG. 12 shows an event sequence in which reference time information is attached by the attaching process execution unit 32A. Note that it is assumed that “11/27” is acquired as an accurate time of occurrence of an event corresponding to an event identification information unit whose last modified time is “8/22” in the event sequence shown in the left part in FIG. 12.

It should be noted that the time “11/25” of occurrence of an event identification information unit whose last modified time is “11/25” and to which reference time information is attached is inconsistent with the accurate time “11/27” of occurrence thereof. That is, the occurrence of the event identification information unit whose last modified time is “11/25” and to which reference time information is attached should be later than the occurrence of the event identification information unit whose last modified time is “8/22” in the order of occurrences. However, the time “11/25” of occurrence of the event identification information unit whose last modified time is “11/25” and to which reference time information is attached is earlier than “11/27”, i.e., earlier than the accurate time of occurrence. Therefore, there is inconsistency. Therefore, as shown in the right part in FIG. 12, the correction execution unit 32B deletes the reference time information from the event identification information unit whose last modified time is “11/25”. Further, the correction execution unit 32B corrects the last modified time of the event identification information unit corresponding to the accurate time “11/27” of occurrence to “11/27” and attaches reference time information to this event identification information unit.

The estimation unit 33 estimates an occurrence period of each of event identification information units included in the event sequence for which reference time information has been corrected by the correction execution unit 32B by using the method described above in the first and second example embodiments.

### Other Example Embodiment

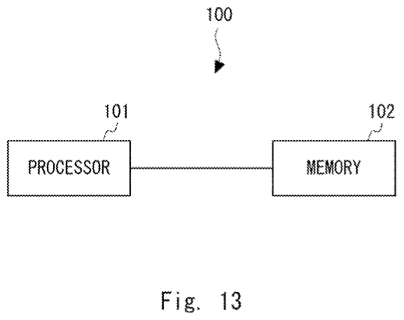

FIG. 13 is a diagram showing an example of a hardware configuration of the estimation apparatus. In FIG. 13, the estimation apparatus 100 includes a processor 101 and a memory 102. The processor 101 may be, for example, a microprocessor, an MPU (Micro Processing Unit), or a CPU (Central Processing Unit). The processor 101 may include a plurality of processors. The memory 102 is formed by a combination of a volatile memory and a nonvolatile memory. The memory 102 may include a storage located remotely from the processor 101. In this case, the processor 101 may access the memory 102 through an I/O interface (not shown).

Each of the estimation apparatuses 10, 20 and 30 according to the first to third example embodiments may have a hardware configuration shown in FIG. 13. Each of the acquisition units 11 and 31, the execution units 12 and 32, and the estimation units 13, 21 and 33 of the estimation apparatuses 10, 20 and 30 according to the first to third example embodiments may be implemented by having the processor 101 load a program(s) stored in the memory 102 and execute the loaded program(s). The programs may be stored in various types of non-transitory computer readable media and thereby supplied to the estimation apparatuses 10, 20 and 30. The non-transitory computer readable media includes various types of tangible storage media. Examples of the non-transitory computer readable media include a magnetic recording medium (such as a flexible disk, a magnetic tape, and a hard disk drive) and a magneto-optic recording medium (such as a magneto-optic disk). Further, examples of the non-transitory computer readable media include CD-ROM (Read Only Memory), CD-R, and CD-R/W. Further, examples of the non-transitory computer readable media include a semiconductor memory. The semiconductor memory includes, for example, a mask ROM, a PROM (Programmable ROM), an EPROM (Erasable PROM), a flash ROM, and a RAM (Random Access Memory). These programs may be supplied to the estimation apparatuses 10, 20 and 30 by using various types of transitory computer readable media. Examples of the transitory computer readable media include an electrical signal, an optical signal, and an electromagnetic wave. The transitory computer readable media can be used to supply programs to the estimation apparatuses 10, 20 and 30 through a wired communication line (e.g., electric wires and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

### REFERENCE SIGNS LIST

10 ESTIMATION APPARATUS
11 ACQUISITION UNIT
12 EXECUTION UNIT
13 ESTIMATION UNIT
20 ESTIMATION APPARATUS
21 ESTIMATION UNIT
30 ESTIMATION APPARATUS
31 ACQUISITION UNIT
32 EXECUTION UNIT
32A ATTACHING PROCESS EXECUTION UNIT
32B CORRECTION EXECUTION UNIT
33 ESTIMATION UNIT

What is claimed is:

1. An estimation apparatus comprising:
at least one memory storing instructions; and
at least one processor configured to execute, according to the instructions, a process comprising:
acquiring an event sequence in which a plurality of event identification information units about a plurality of respective events are arranged in the order of occurrences of these events and each of the event identification information units is associated with a last modified time of a file corresponding to that event identification information unit;
performing a reference time information attaching process in which the execution means repeats, until an end condition is satisfied, processes including setting a search range for the event sequence, identifying an event identification information unit whose last modified time is closest to the present time among event identification information units included in the search range, attaching reference time information to the identified event identification information unit, and setting a next search range for all event identification information units that are earlier than the identified event identification information unit in the order of occurrences in the event sequence; and
estimating, for each of the event identification information units included in the event sequence, an occurrence period in which an event of that event identification information unit occurred based on the last modified time of the event identification information unit to which the reference time information was attached by the reference time information attaching process.

2. The estimation apparatus according to claim 1, wherein the estimating includes estimating that an occurrence period of a third event identification information unit with no reference time information attached thereto, located between first and second event identification information units to each of which respective reference time information is attached in the event sequence, corresponds to a period that starts at the last modified time of the second event identification information unit and ends at the last modified time of the first event identification information unit.

3. The estimation apparatus according to claim 2, wherein the estimating includes selecting, as the above-described first event identification information unit, an event identification information unit which is Nth closest to the above-described third event identification information unit (N is an integer) among event identification information units which are later than the above-described third event identification information unit in the order of occurrences in the event sequence and to each of which reference time information is attached, and selecting, as the above-described second event identification information unit, an event identification information unit which is Mth closest to the above-described third event identification information unit (M is an integer) among event identification information units which are earlier than the above-described third event identification information unit in the order of occurrences in the event sequence and to each of which reference time information is attached.

4. The estimation apparatus according to claim 2, wherein when there is no event identification information unit which is later than the first event identification information unit in the order of occurrences in the event sequence and to which reference time information is attached, the estimating includes estimating that an occurrence period of a fourth event identification information unit which is later than the first event identification information unit in the order of occurrences in the event sequence and to which no reference time information is attached corresponds to a period that starts at the last modified time of the first event identification information unit.

5. The estimation apparatus according to claim 2, wherein when there is no event identification information unit which is earlier than the second event identification information unit in the order of occurrences in the event sequence and to which reference time information is attached, the estimating includes estimating that an occurrence period of a fifth event identification information unit which is earlier than the second event identification information unit in the order of occurrences in the event sequence and to which no reference time information is attached corresponds to a period that ends at the last modified time of the second event identification information unit.

6. The estimation apparatus according to claim 1, wherein
the acquiring includes acquiring an accurate time of occurrence of at least one of the plurality of events, and
the performing comprises:
performing the reference time information attaching process; and
deleting the reference time information of the event identification information unit with the reference time information attached thereto, corresponding to the last modified time that is inconsistent with the acquired accurate time of occurrence, and attaching the reference time information to the event identification information unit corresponding to the at least one event.

7. The estimation apparatus according to claim 1, wherein the end condition is a fact that the number of event identification information units that are earlier than the identified event identification information unit in the order of occurrences in the event sequence is equal to or smaller than a predetermined number or is zero, or a fact that the number of repetitions reaches a predetermined number.

8. An estimation method comprising:
acquiring an event sequence in which a plurality of event identification information units about a plurality of respective events are arranged in the order of occurrences of these events and each of the event identification information units is associated with a last modified time of a file corresponding to that event identification information unit;
performing a reference time information attaching process in which setting a search range for the event sequence, identifying an event identification information unit whose last modified time is the latest among event identification information units included in the search range, attaching reference time information to the identified event identification information unit, and setting a next search range for all event identification information units that are earlier than the identified event identification information unit in the order of occurrences in the event sequence are repeated until an end condition is satisfied; and
estimating, for each of the event identification information units included in the event sequence, an occurrence period in which an event of that event identification information unit occurred based on the last modified time of the event identification information unit to which the reference time information was attached by the reference time information attaching process.

9. A non-transitory computer readable medium storing a program for causing an estimation apparatus to:
acquire an event sequence in which a plurality of event identification information units about a plurality of respective events are arranged in the order of occurrences of these events and each of the event identification information units is associated with a last modified time of a file corresponding to that event identification information unit;
perform a reference time information attaching process in which setting a search range for the event sequence, identifying an event identification information unit whose last modified time is the latest among event identification information units included in the search range, attaching reference time information to the identified event identification information unit, and setting a next search range for all event identification information units that are earlier than the identified event identification information unit in the order of occurrences in the event sequence are repeated until an end condition is satisfied; and
estimate, for each of the event identification information units included in the event sequence, an occurrence period in which an event of that event identification information unit occurred based on the last modified time of the event identification information unit to which the reference time information was attached by the reference time information attaching process.
